(19) United States
(12) Patent Application Publication
(10) Pub. No.: US 2013/0241193 A1
(43) Pub. Date: Sep. 19, 2013

(54) ENCLOSURE WITH SHEILDING ASSEMBLY

(71) Applicant: XU YANG, Shenzhen City (CN)

(72) Inventor: XU YANG, Shenzhen City (CN)

(21) Appl. No.: 13/660,338

(22) Filed: Oct. 25, 2012

(30) Foreign Application Priority Data
Mar. 19, 2012 (CN) 201210072382.X

(51) Int. Cl. F16L 5/02

(52) U.S. Cl. 285/46

(57) ABSTRACT

An enclosure includes a rear wall, a rail assembly, and a shielding assembly. The rear wall defines a pipe hole for receiving pipe. The rail assembly is attached to the rear wall. The rail assembly defines a sliding space. The shielding assembly includes a fixing member fixed on the rear wall, a pole, and a shielding board. The pole is connected to the shielding board and movably attached to the fixing member. The shielding board is movable in the sliding space along a direction substantially parallel to the rear wall to shield the pipe hole around the pipe.

### BACKGROUND

1. Technical Field

The disclosure generally relates to enclosures with shielding assembles for shielding pipe holes.

2. Description of Related Art

Electrical devices, such as computers, include enclosures for receiving electronic components. Some electronic components may generate heat, and the heat needs to be dissipated from the enclosure. Traditional heat dissipation includes heat sink and fans. To reach high heat dissipation effect, water-cooling device is used. Holes are needed in the enclosure for receiving water pipes for water-cooling enclosure. However, dust or water may enter the enclosure through misfit holes in size for pipes will affect the electronic device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partial exploded view of an enclosure in one embodiment.

FIG. 2 is an assembled, isometric view of a shielding assembly of FIG. 1.

FIG. 3 is an assembled view of the enclosure of FIG. 1.

FIG. 4 is an enlarged view of a circled portion IV of FIG. 3.

FIG. 5 is similar to FIG. 4, but the shielding assembly is open.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

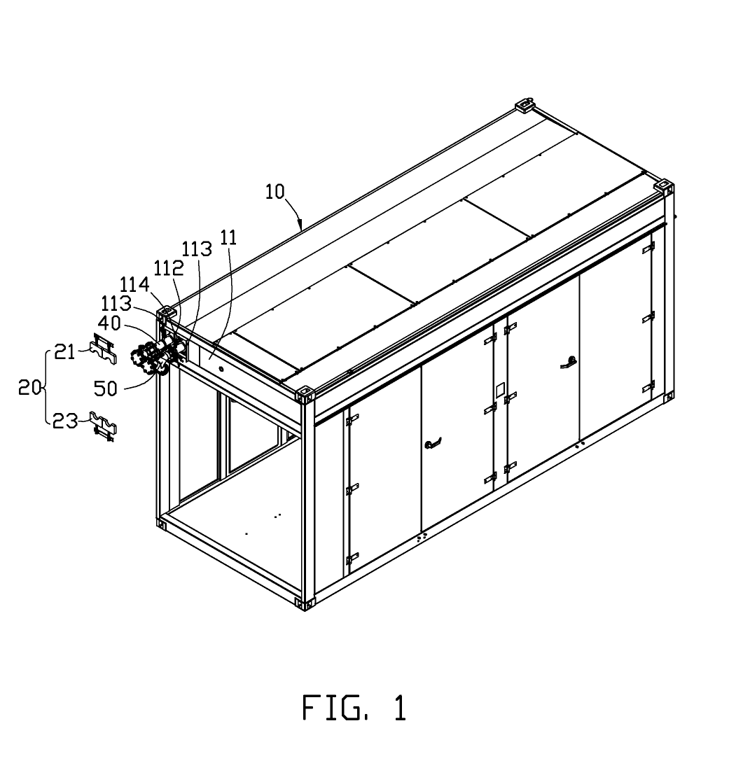

Referring to FIG. 1, in one embodiment, an enclosure 10 includes a rear wall 11, a rail assembly 14, and a shielding assembly 20. Two pipe holes 112 are defined in the rear wall 11 for receiving pipes. The pipes may include an input pipe 40 and an output pipe 50.

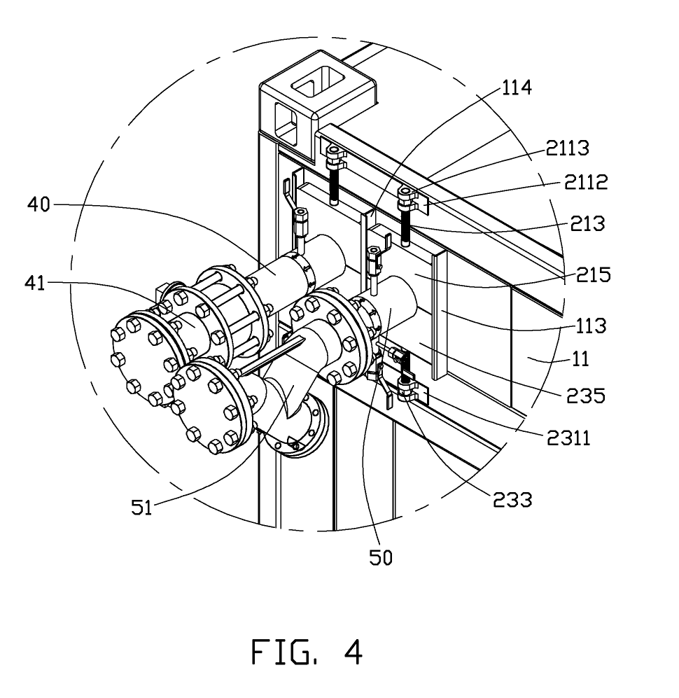

Referring to FIG. 4, the input pipe 40 is connected to an input valve 41, and output pipe 50 is connected to an output valve 51.

The rail assembly 114 defines two sliding spaces each braced by two side flanges 113. The rail assembly 114 is fixed on the rear wall 11 adjacent to the pipe holes 112.

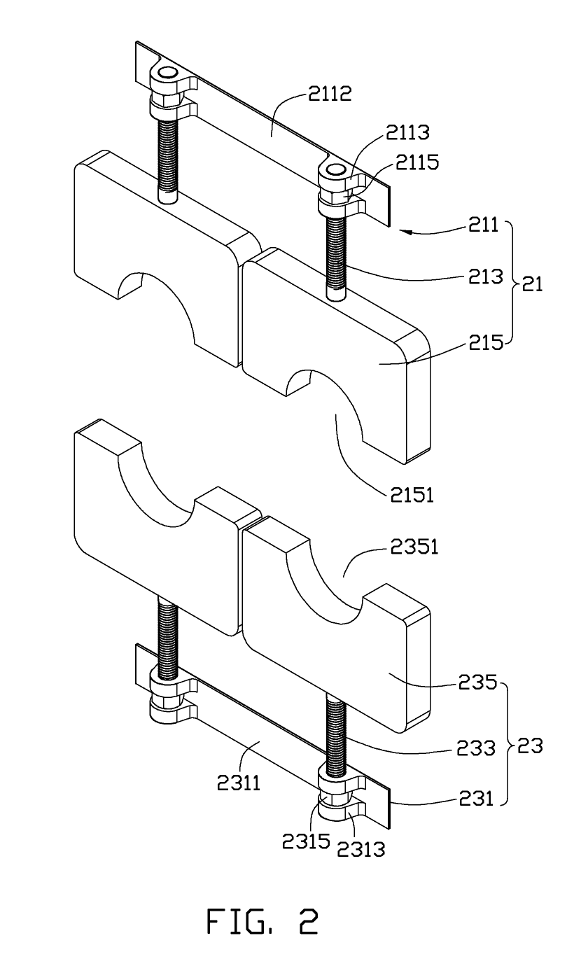

Referring to FIG. 2, the shielding assembly 20 includes a top shielding device 21 and a bottom shielding device 23. The top shielding device 21 includes a top fixing member 211, two top poles 213, and two top shielding members 215. The top fixing member 211 includes a top fixing panel 2112, two pairs of top locating members 2113, and two top nuts 2115. The top fixing panel 2112 is substantially a sheet. The two pairs of top locating portions 2113 are located on the top fixing panel 2112. Each pair of locating portions 2113 is spaced and aligned along a vertical direction. Each pair of top locating portions 2113 defines a through hole. Each of the top nuts 2115 has inner thread. The each top pole 213 is located on each top shielding board 215. Each top pole 213 has outer thread to engage with each top nut 2115. Each top shielding board 215 defines a cutout 2151. The cutout 2151 is substantially a semicircle.

The bottom shielding device 23 has substantially the same structure to the top shielding device 21. The bottom shielding device 23 includes a bottom fixing member 231, two bottom poles 233, and two bottom shielding members 235. The bottom shielding device 23 includes a bottom fixing member 231, two bottom poles 233, and two bottom shielding members 235. The bottom fixing member 231 includes a bottom fixing panel 2311, two pairs of bottom locating members 2313, and two top nuts 2315.

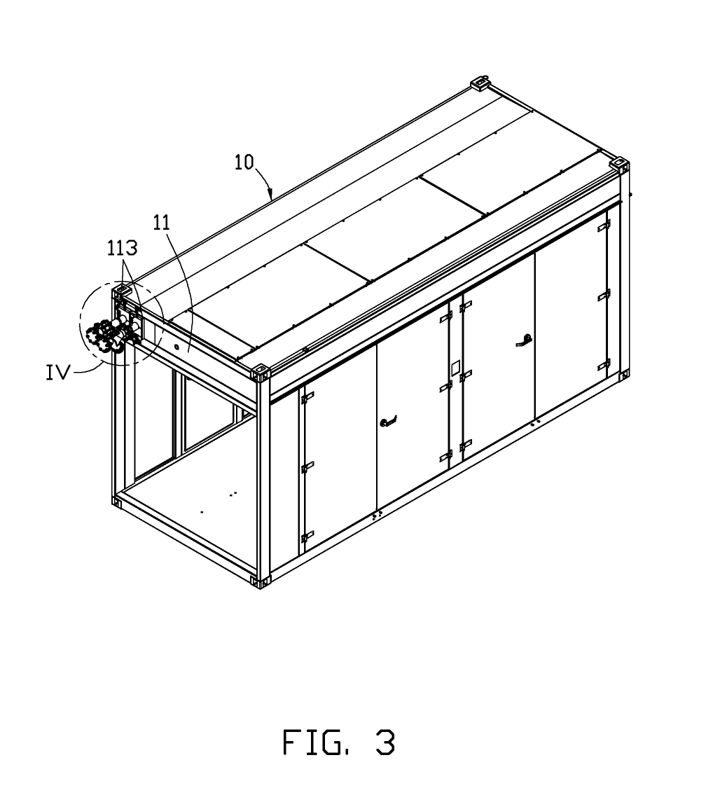

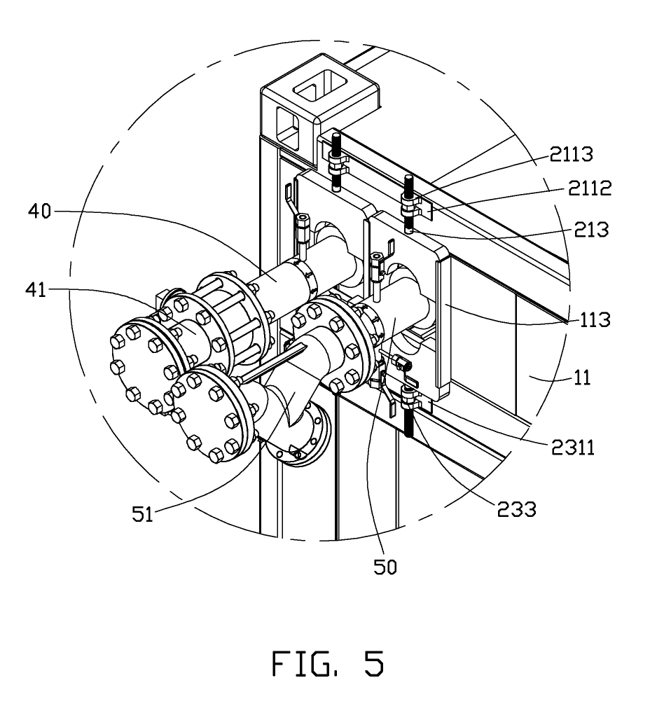

Referring through FIG. 3 to FIG. 5, in assembly, the input pipe 40 and the output pipe 50 extends through the pipe holes 112 of rear wall 11. The rail assembly 14 is fixed on the rear wall 11. The top fixing panel 2112 and the bottom fixing panel 2311 are fixed on the rear wall 11. Each top shielding board 215 with the top pole 213 and each bottom shielding board 235 with the bottom pole 233 are engaged with the top fixing 211 and the bottom fixing member 231, respectively. Take one top shielding board 215 for example, the top nut 2115 is located between the pair of top locating portions 2113. The top pole 213 extends through the pair of locating portions 2113 and is engaged with the top nut 2115. The top shielding board 215 is substantially parallel to the rear wall 11.

In use, the top nut 2115 is rotated, the top pole 213 moves relative to the top nut 2115 and the shielding board 215 is lifted up or dropped down. The bottom nut 2315 is rotated, the bottom pole 233 moves relative to the bottom nut 2315, and the shielding board 235 is lifted up or dropped down. Each top shielding board 215 and each bottom shielding board 235 are moved in the sliding space of the rail assembly 114 towards each other, along a direction substantially parallel to the rear wall 11 to shield the pipe holes 112 around the input pipe 40 and the output pipe 50.

It is also understood, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An enclosure comprising:
a rear wall, defining a pipe hole for receiving pipe;
a rail assembly attached to the rear wall, the rail assembly defines a sliding space; and
a shielding assembly, comprising a fixing member fixed on the rear wall, a pole, and a shielding board; and the pole is connected to the shielding board and movably attached to the fixing member;
wherein the shielding board is movable in the sliding space, along a direction that is substantially parallel to the rear wall to shield the pipe hole around the pipe.

2. The enclosure of claim 1, wherein the fixing member comprises a pair of locating portions, and each of the pair of locating portions defines a through hole for receiving the pole.

3. The enclosure of claim 2, wherein the fixing member further comprises a nut, the nut comprises inner thread; the pole has outer thread engage with the nut; the nut is located between the pair of locating portions.

4. The enclosure of claim 1, wherein the rail assembly comprises a pair of side flanges on opposite sides of the shielding board, and the pair of side flanges extends along a moving direction of the shielding board.

5. The enclosure of claim 4, wherein each of the pair of side flanges is L-shaped in cross section.

6. The enclosure of claim 1, wherein the shielding board defines a cutout coupled to the pipe.

7. An enclosure comprising:
a rear wall, defining a pipe hole for receiving pipe; and
a shielding assembly, comprising two fixing members fixed on the rear wall, two poles, and a pair of shielding boards, each of the two poles connects to each of the pair of shielding boards and movably attached to each of the two fixing members;
wherein the pair of shielding boards are movable towards each other to cooperatively shield the pipe hole around the pipe.

8. The enclosure of claim 7, wherein each of the two fixing members comprises two locating portions, and each of the two locating portions defines a through hole for receiving each of the two poles.

9. The enclosure of claim 8, wherein each of the two fixing members further comprises a nut, the nut comprises inner thread; each of the two poles has outer thread engage with the nut; and the nut is located between the two locating portions.

10. The enclosure of claim 7, further comprising a rail assembly attached to the rear wall, the rail assembly defines a sliding space; and the pair of shielding boards is movable in the sliding space.

11. The enclosure of claim 10, wherein the rail assembly comprises a pair of side flanges bracing the pair of shielding boards, and the pair of side flanges extends along a moving direction of each of the pair of shielding boards.

12. The enclosure of claim 11, wherein each of the pair of side flanges is L-shaped in cross section.

13. The enclosure of claim 7, wherein the pair of shielding boards defines two cutouts coupled to the pipe.

14. The enclosure of claim 7, wherein the pair of shielding boards is adjacent to and substantially parallel to the rear wall.

15. An enclosure comprising:
a rear wall, defining a pipe hole for receiving pipe; and
a shielding assembly, comprising two fixing members fixed on the rear wall, two poles, and a pair of shielding boards, each of the two poles connects to each of the pair of shielding boards and movably attached to each of the two fixing members;
wherein the two shielding boards are adjacent to and substantially parallel to the rear wall.

16. The enclosure of claim 15, wherein each of the fixing members comprises two locating portions, and each of the two locating portions defines a through hole for receiving each of the two poles.

17. The enclosure of claim 16, wherein each of the two fixing members further comprises a nut, the nut comprises inner thread; each of the two poles has outer thread engage with the nut; and the nut is located between the two locating portions.

18. The enclosure of claim 16, further comprising a rail assembly attached to the rear wall, the rail assembly defines a sliding space; and the pair of shielding boards is movable in the sliding space.

19. The enclosure of claim 16, wherein the pair of shielding board defines two cutouts coupled to the pipe.

20. The enclosure of claim 16, wherein the pair of shielding boards are movable towards each other to cooperatively shield the pipe hole around the pipe.
